(19) United States
(12) Patent Application Publication
(10) Pub. No.: US 2019/0292747 A1
(43) Pub. Date: Sep. 26, 2019

(54) CONTROL SYSTEM OF CONSTRUCTION MACHINE, CONSTRUCTION MACHINE, AND CONTROL METHOD OF CONSTRUCTION MACHINE

(71) Applicant: Komatsu Ltd., Tokyo (JP)

(72) Inventors: Kazuki Takehara, Tokyo (JP); Masashi Ichihara, Tokyo (JP); Yoshiro Iwasaki, Tokyo (JP)

(21) Appl. No.: 16/301,503

(22) PCT Filed: Aug. 1, 2017
(86) PCT No.: PCT/JP2017/027910

§ 371 Date: Nov. 14, 2018

(30) Foreign Application Priority Data
Aug. 12, 2016 (JP) 2016-158832

(51) Int. Cl. E02F 3/42; E02F 3/43; E02F 9/20

(52) U.S. Cl. CPC E02F 3/422; E02F 3/432; E02F 9/02; B60Y 2200/412; E02F 9/20

(57) ABSTRACT

Provided is a control system of a construction machine provided with working equipment including an arm and a bucket configured to rotate around each of a bucket axis and a tilt axis orthogonal to the bucket axis with respect to the arm. The control system includes: an angle determination unit configured to determine a tilt angle indicating an angle of a specific portion of the bucket around the tilt axis so that a target construction topography indicating a target shape of an excavation object and the specific portion of the bucket become parallel to each other; and a working equipment control unit configured to control a tilt cylinder configured to rotate the bucket around the tilt axis on the basis of the tilt angle determined by the angle determination unit.

### FIELD

The present invention relates to a control system of a construction machine, a construction machine, and a control method of a construction machine.

### BACKGROUND

A construction machine provided with working equipment including a tilt-type bucket as disclosed in Patent Literature 1 is known.

### CITATION LIST

### Patent Literature

Patent Literature 1: WO 2015/186179 A

### SUMMARY

### Technical Problem

In a technical field related to control of the construction machine, a technology of controlling working equipment in preference to an operation of an operation device by an operator of the construction machine is known. In this specification, working equipment control in preference to the operation of the operation device by the operator of the construction machine is referred to as intervention control.

In the intervention control, a position or a posture of at least one of a boom, an arm, and a bucket of the working equipment is controlled with respect to a target construction topography indicating a target shape of an excavation object. The intervention control is performed, and thus construction conforming to the target construction topography is performed.

In the construction machine including the tilt-type bucket, when control specific to the tilt-type bucket is not performed in addition to the existing intervention control, work efficiency of the construction machine deteriorates.

An object of aspects of the invention is to provide a control system of a construction machine which is capable of suppressing deterioration of work efficiency in a construction machine provided with working equipment including a tilt-type bucket, a construction machine, and a control method of a construction machine.

### Solution to Problem

According to a first aspect of the present invention, a control system of a construction machine provided with working equipment including an arm and a bucket configured to rotate around each of a bucket axis and a tilt axis orthogonal to the bucket axis with respect to the arm, the control system comprises: an angle determination unit configured to determine a tilt angle indicating an angle of a specific portion of the bucket around the tilt axis so that a target construction topography indicating a target shape of an excavation object and the specific portion of the bucket become parallel to each other; and a working equipment control unit configured to control a tilt cylinder configured to rotate the bucket around the tilt axis on the basis of the tilt angle determined by the angle determination unit.

According to a second aspect of the present invention, a construction machine, comprises: an upper swing body; a lower travel body configured to support the upper swing body; working equipment that includes the arm and the bucket, the working equipment being configured to be supported to the upper swing body; and the control system of the construction machine according to the first aspect.

According to a third aspect of the present invention, a control method of a construction machine provided with working equipment including an arm and a bucket configured to rotate around each of a bucket axis and a tilt axis orthogonal to the bucket axis with respect to the arm, the control method comprises: determining a tilt angle indicating an angle of a specific portion of the bucket around the tilt axis so that a target construction topography indicating a target shape of an excavation object and the specific portion of the bucket become parallel to each other; and controlling a tilt cylinder configured to rotate the bucket around the tilt axis on the basis of the tilt angle determined by the angle determination unit.

### Advantageous Effects of Invention

According to the aspects of the invention, a control system of a construction machine which is capable of suppressing deterioration of work efficiency in a construction machine provided with working equipment including a tilt-type bucket, a construction machine, and a control method of a construction machine are provided.

### BRIEF DESCRIPTION OF DRAWINGS

FIG. 1 is a perspective view illustrating an example of a construction machine according to this embodiment.

FIG. 2 is a side cross-sectional view illustrating an example of a bucket according to this embodiment.

FIG. 3 is a front view illustrating an example of the bucket according to this embodiment.

FIG. 4 is a side view schematically illustrating an excavator according to this embodiment.

FIG. 5 is a rear view schematically illustrating the excavator according to this embodiment.

FIG. 6 is a plan view schematically illustrating the excavator according to this embodiment.

FIG. 7 is a side view schematically illustrating the bucket according to this embodiment.

FIG. 8 is a front view schematically illustrating the bucket according to this embodiment.

FIG. 9 is a schematic view illustrating an example of a hydraulic system according to this embodiment.

FIG. 10 is a schematic view illustrating an example of the hydraulic system according to this embodiment.

FIG. 11 is a functional block diagram illustrating an example of a control system according to this embodiment.

FIG. 12 is a view schematically illustrating an example of a definition point that is set to the bucket according to this embodiment.

FIG. 13 is a schematic view illustrating an example of target construction data according to this embodiment.

FIG. 14 is a schematic view illustrating an example of a target construction topography according to this embodiment.

FIG. 15 is a schematic view illustrating an example of a tilt operation plane according to this embodiment.

FIG. 16 is a schematic view illustrating an example of the tilt operation plane according to this embodiment.

FIG. 17 is a view schematically illustrating a relationship between a blade edge of the bucket and the target construction topography according to this embodiment.

FIG. 18 is a schematic view illustrating intervention control related to tilt rotation according to this embodiment.

FIG. 19 is a view illustrating an example of a relationship between an operation distance and a target speed according to this embodiment.

FIG. 20 is a flowchart illustrating an example of a method of adjusting a tilt angle of the bucket according to this embodiment.

FIG. 21 is a schematic view illustrating an example of the method of adjusting the tilt angle of the bucket according to this embodiment.

FIG. 22 is a view schematically illustrating an example of an operation of working equipment according to this embodiment.

FIG. 23 is a view schematically illustrating an example of the operation of the working equipment according to this embodiment.

FIG. 24 is a flowchart illustrating an example of the method of adjusting the tilt angle of the bucket according to this embodiment.

FIG. 25 is a schematic view illustrating an example of the method of adjusting the tilt angle of the bucket according to this embodiment.

FIG. 26 is a schematic view illustrating an example of the method of adjusting the tilt angle of the bucket according to this embodiment.

### DESCRIPTION OF EMBODIMENTS

Hereinafter, embodiments according to the invention will be described with reference to the accompanying drawings, but the invention is not limited thereto. Constituent elements of the following respective embodiments can be appropriately combined with each other. In addition, partial constituent elements may not be used.

In the following description, a positional relationship of respective portions will be described by specifying a three-dimensional global coordinate system (Xg, Yg, and Zg), and a three-dimensional vehicle body coordinate system (Xm, Ym, and Zm).

The global coordinate system represents a coordinate system in which the original point fixed to the globe is set as a reference. The global coordinate system is a coordinate system that is defined by a global navigation satellite system (GNSS). The GNSS represents a global navigation satellite system. As an example of the global navigation satellite system, a global positioning system (GPS) can be exemplified. The GNSS includes a plurality of positioning satellites. The GNSS detects a position that is defined by coordinate data of a latitude, a longitude, and altitude.

The global coordinate system is defined by an Xg axis in a horizontal plane, a Yg axis that is orthogonal to the Xg axis in the horizontal plane, and a Zg axis that is orthogonal to the Xg axis and the Yg axis. A direction parallel to the Xg axis is set as an Xg axis direction, a direction parallel to the Yg axis is set as a Yg axis direction, and a direction parallel to the Zg axis is set as a Zg axis direction. In addition, a rotation or inclination direction around the Xg axis is set as a θXg direction, a rotation or inclination direction around the Yg axis is set as a θYg direction, and a rotation or inclination direction around the Zg axis is set as a θZg direction. The Zg axis direction is a vertical direction.

The vehicle body coordinate system represents a coordinate system in which the original point fixed to construction machine is set as a reference.

The vehicle body coordinate system is defined by an Xm axis that extends in one direction with the original point fixed to a vehicle body of a construction machine set as a reference, a Ym axis that is orthogonal to the Xm axis, a Zm axis that is orthogonal to the Xm axis and the Ym axis. A direction parallel to the Xm axis is set as an Xm axis direction, a direction parallel to the Ym axis is set as a Ym axis direction, and a direction parallel to the Zm axis is set as a Zm axis direction. In addition, a rotation or inclination direction around the Xm axis is set as a θXm direction, a rotation or inclination direction around the Ym axis is set as a θYm direction, and a rotation or inclination direction around the Zm axis is set as a θZm direction. The Xm axis direction is a front and back direction of the construction machine, the Ym axis direction is a vehicle width direction of the construction machine, and the Zm axis direction is an upper and lower direction of the construction machine.

### First Embodiment

[Construction Machine]

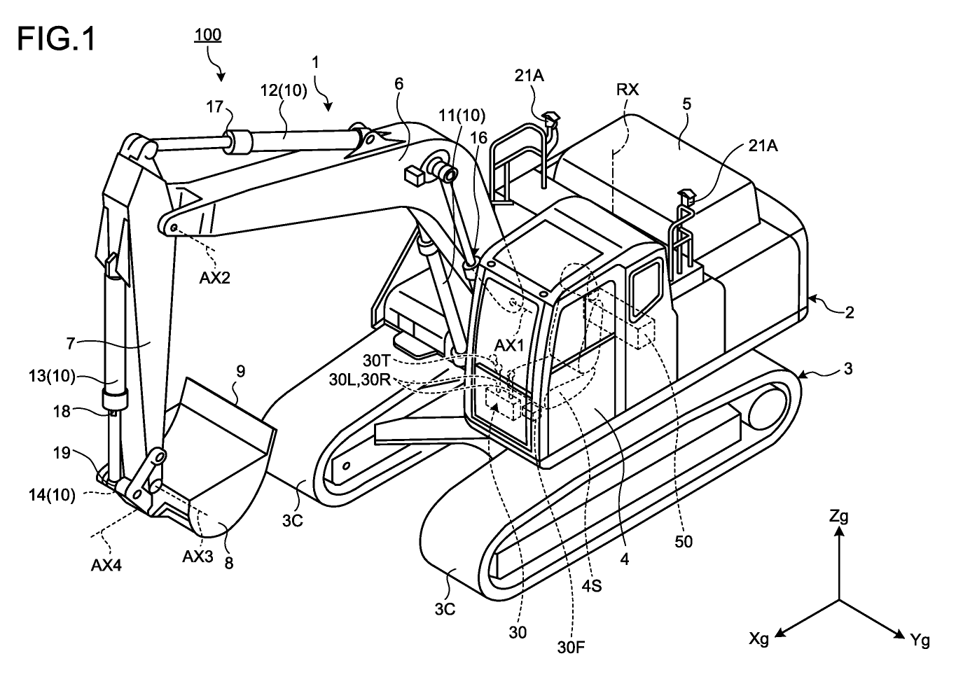

FIG. 1 is a perspective view illustrating an example of a construction machine 100 according to this embodiment. In this embodiment, description will be given of an example in which the construction machine 100 is an excavator. In the following description, the construction machine 100 is appropriately referred to as an excavator 100.

As illustrated in FIG. 1, the excavator 100 includes working equipment 1 that is operated by a hydraulic pressure, an upper swing body 2 that is a vehicle body that supports the working equipment 1, a lower travel body 3 that is a travel device that supports the upper swing body 2, an operation device 30 that operates the working equipment 1, and a control device 50 that controls the working equipment 1. The upper swing body 2 can swing around a swing axis RX in a state of being supported to the lower travel body 3.

The upper swing body 2 includes a driving chamber 4 in which an operator rides, and a machine chamber 5 in which an engine and a hydraulic pump are accommodated. The driving chamber 4 includes a driver's seat 4S on which the operator sits. The machine chamber 5 is disposed on a rearward side of the driving chamber 4.

The lower travel body 3 includes a pair of crawlers 3C. The excavator 100 travels due to rotation of the crawlers 3C. Furthermore, the lower travel body 3 may include tires.

The working equipment 1 is supported to the upper swing body 2. The working equipment 1 includes a boom 6 that is connected to the upper swing body 2 through a boom pin, an arm 7 that is connected to the boom 6 through an arm pin, and a bucket 8 that is connected to the arm 7 through a bucket pin and a tilt pin. The bucket 8 includes a blade edge 9. In this embodiment, the blade edge 9 of the bucket 8 is a tip end of a straight blade provided in the bucket 8. Furthermore, the blade edge 9 of the bucket 8 may be a tip end of a convex blade provided in the bucket 8.

The boom 6 can rotate around a boom axis AX1 that is a rotation axis with respect to the upper swing body 2. The arm 7 can rotate around an arm axis AX2 that is a rotation axis with respect to the boom 6. The bucket 8 can rotate around a bucket axis AX3 that is a rotation axis and a tilt axis AX4 that is a rotation axis orthogonal to the bucket axis AX3 with respect to the arm 7. The rotation axis AX1, the rotation axis AX2, and the rotation axis AX3 are parallel to each other. The rotation axes AX1, AX2, and AX3, and an axis parallel to the swing axis RX are orthogonal to each other. The rotation axes AX1, AX2, and AX3 are parallel to the Ym axis of the vehicle body coordinate system. The swing axis RX is parallel to the Zm axis of the vehicle body coordinate system. A direction parallel to the rotation axes AX1, AX2, and AX3 represents a vehicle width direction of the upper swing body 2. A direction parallel to the swing axis RX represents an upper and lower direction of the upper swing body 2. A direction orthogonal to both the rotation axes AX1, AX2, and AX3, and the swing axis RX represents a front and back direction of the upper swing body 2. A direction in which the working equipment 1 exists on the basis of the operator who sits on the driver's seat 4S is a forward side.

The working equipment 1 operates by the power generated by a hydraulic cylinder 10. The hydraulic cylinder 10 includes a boom cylinder 11 that operates the boom 6, an arm cylinder 12 that operates the arm 7, and a bucket cylinder 13 and a tilt cylinder 14 which operate the bucket 8. The boom cylinder 11 can generate power for rotating the boom 6 around the boom axis AX1. The arm cylinder 12 can generate power for rotating the arm 7 around an arm axis AX2. The bucket cylinder 13 can generate power for rotating the bucket 8 around a bucket axis AX3. The tilt cylinder 14 can generate power for rotating the bucket 8 around a tilt axis AX4.

In the following description, rotation of the bucket 8 around the bucket axis AX3 is appropriately referred to as bucket rotation, and rotation of the bucket 8 around the tilt axis AX4 is appropriately referred to as tilt rotation.

In addition, the working equipment 1 includes a boom stroke sensor 16 that detects a boom stroke indicating the amount of driving of the boom cylinder 11, an arm stroke sensor 17 that detects an arm stroke indicating the amount of driving of the arm cylinder 12, a bucket stroke sensor 18 that detects a bucket stroke indicating the amount of the driving of the bucket cylinder 13, and a tilt stroke sensor 19 that detects a tilt stroke indicating the amount of driving of the tilt cylinder 14. The boom stroke sensor 16 is disposed at the boom cylinder 11. The arm stroke sensor 17 is disposed at the arm cylinder 12. The bucket stroke sensor 18 is disposed at the bucket cylinder 13. The tilt stroke sensor 19 is disposed at the tilt cylinder 14.

The operation device 30 is disposed in the driving chamber 4. The operation device 30 includes an operation member that is operated by an operator of the excavator 100. The operator operates the working equipment 1 by operating the operation device 30. In this embodiment, the operation device 30 includes a right working equipment operation lever 30R, a left working equipment operation lever 30L, a tilt operation lever 30T, and an operation pedal 30F.

When the right working equipment operation lever 30R located at the neutral position is operated to a forward side, the boom 6 operates downward, and when the right working equipment operation lever 30R is operated to a backward side, the boom 6 operates upward. When the right working equipment operation lever 30R located at the neutral position is operated to a right side, the bucket 8 performs dumping, and when the right working equipment operation lever 30R is operated to a left side, the bucket 8 performs excavation.

When the left working equipment operation lever 30L located at the neutral position is operated to a forward side, the arm 7 performs dumping, and when the left working equipment operation lever 30L is operated to a backward side, the arm 7 performs excavation. When the left working equipment operation lever 30L located at the neutral position is operated to a right side, the upper swing body 2 swings to the right, and when the left working equipment operation lever 30L is operated to a left side, the upper swing body 2 swings to the left.

Furthermore, the relationship between the operation direction of the right working equipment operation lever 30R and the left working equipment operation lever 30L, and the operation direction of the working equipment 1 and the swing direction of the upper swing body 2 may not be the above-described relationship.

The control device 50 includes a computer system. The control device 50 includes a processor such as a central processing unit (CPU), a storage device including a non-volatile memory such as a read only memory (ROM), and a volatile memory such as a random access memory (RAM), and an input/output interface device.

[Bucket]

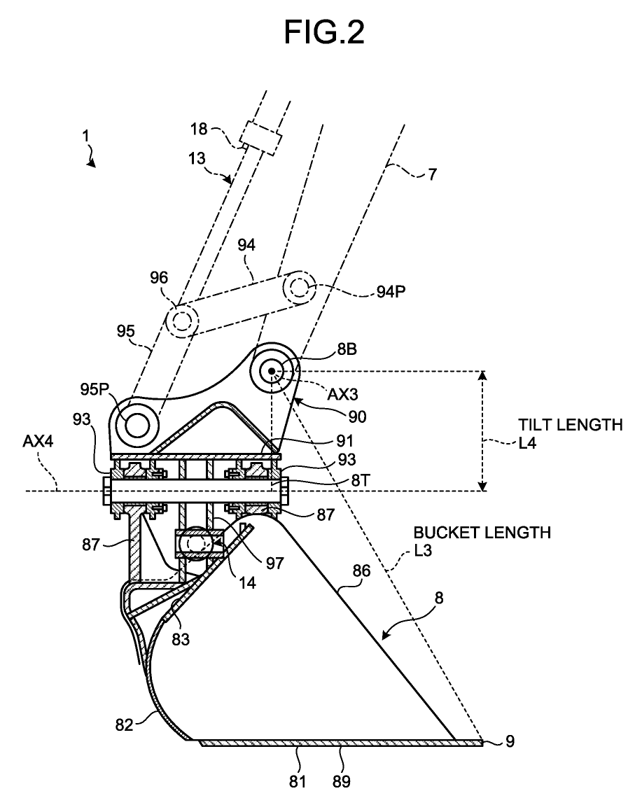

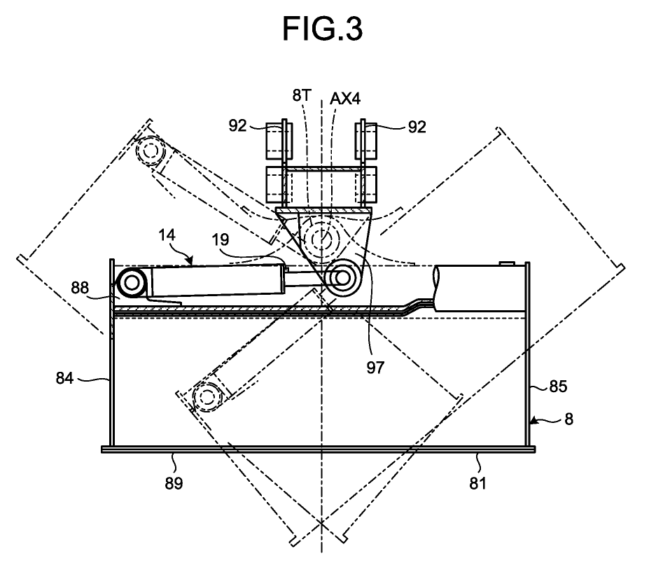

Next, the bucket 8 according to this embodiment will be described. FIG. 2 is a side cross-sectional view illustrating an example of the bucket 8 according to this embodiment. FIG. 3 is a front view illustrating an example of the bucket 8 according to this embodiment. In this embodiment, the bucket 8 is a tilt-type bucket.

As illustrated in FIG. 2 and FIG. 3, the working equipment 1 includes the bucket 8 that can rotate around the bucket axis AX3 and the tilt axis AX4 orthogonal to the bucket axis AX3 with respect to the arm 7. The bucket 8 is rotatably connected to the arm 7 through a bucket pin 8B. In addition, the bucket 8 is rotatably supported to the arm 7 through a tilt pin 8T.

The bucket 8 is connected to a tip end of the arm 7 through a connection member 90. The bucket pin 8B connects the arm 7 and the connection member 90 to each other. The tilt pin 8T connects the connection member 90 and the bucket 8 to each other. The bucket 8 is rotatably connected to the arm 7 through the connection member 90.

The bucket 8 includes a bottom plate 81, a rear plate 82, an upper plate 83, a side plate 84, and a side plate 85. An opening 86 of the bucket 8 is defined by the bottom plate 81, the upper plate 83, the side plate 84, and the side plate 85. The blade edge 9 is provided in the bottom plate 81. The bottom plate 81 includes a flat floor surface 89 that is connected to the blade edge 9. The floor surface 89 is a bottom surface of the bottom plate 81. The floor surface 89 is a substantially flat surface.

The bucket 8 includes a bracket 87 that is provided in an upper portion of the upper plate 83. The bracket 87 is provided at front and back positions of the upper plate 83. The bracket 87 is connected to the connection member 90 and the tilt pin 8T.

The connection member 90 includes a plate member 91, a bracket 92 that is provided on an upper surface of the plate member 91, and a bracket 93 that is provided on a lower surface of the plate member 91. The bracket 92 is connected to the arm 7 and a second link pin 95P. The bracket 93 is provided in an upper portion of the bracket 87, and is connected to the tilt pin 8T and the bracket 87.

The bucket pin 8B connects the bracket 92 of the connection member 90 and the tip end of the arm 7 to each other. The tilt pin 8T connects the bracket 93 of the connection member 90 and the bracket 87 of the bucket 8. The connection member 90 and the bucket 8 can rotate around the bucket axis AX3 with respect to the arm 7. The bucket 8 can rotate around the tilt axis AX4 with respect to the connection member 90.

The working equipment 1 includes a first link member 94 that is rotatably connected to the arm 7 through a first link pin 94P, and a second link member 95 that is rotatably connected to the bracket 92 through the second link pin 95P. A base end of the first link member 94 is connected to the arm 7 through the first link pin 94P. A base end of the second link member 95 is connected to the bracket 92 through the second link pin 95P. A tip end of the first link member 94 and a tip end of the second link member 95 are connected to each other through a bucket cylinder top pin 96.

A tip end of the bucket cylinder 13 is rotatably connected to the tip end of the first link member 94 and the tip end of the second link member 95 through the bucket cylinder top pin 96. When the bucket cylinder 13 operates to expand and contract, the connection member 90 rotates around the bucket axis AX3 in combination with the bucket 8.

The tilt cylinder 14 is connected to a bracket 97 that is provided in the connection member 90, and a bracket 88 that is provided in the bucket 8. A rod of the tilt cylinder 14 is connected to the bracket 97 through a pin. A main body portion of the tilt cylinder 14 is connected to the bracket 88 through a pin. When the tilt cylinder 14 operates to expand and contract, the bucket 8 rotates around the tilt axis AX4. Furthermore, the connection structure of the tilt cylinder 14 according to this embodiment is illustrative only, and there is no limitation thereto.

As described above, the bucket 8 rotates around the bucket axis AX3 due to an operation of the bucket cylinder 13. The bucket 8 rotates around the tilt axis AX4 due to an operation of the tilt cylinder 14. When the bucket 8 rotates around the bucket axis AX3, the tilt pin 8T rotates in combination with the bucket 8.

[Detection System]

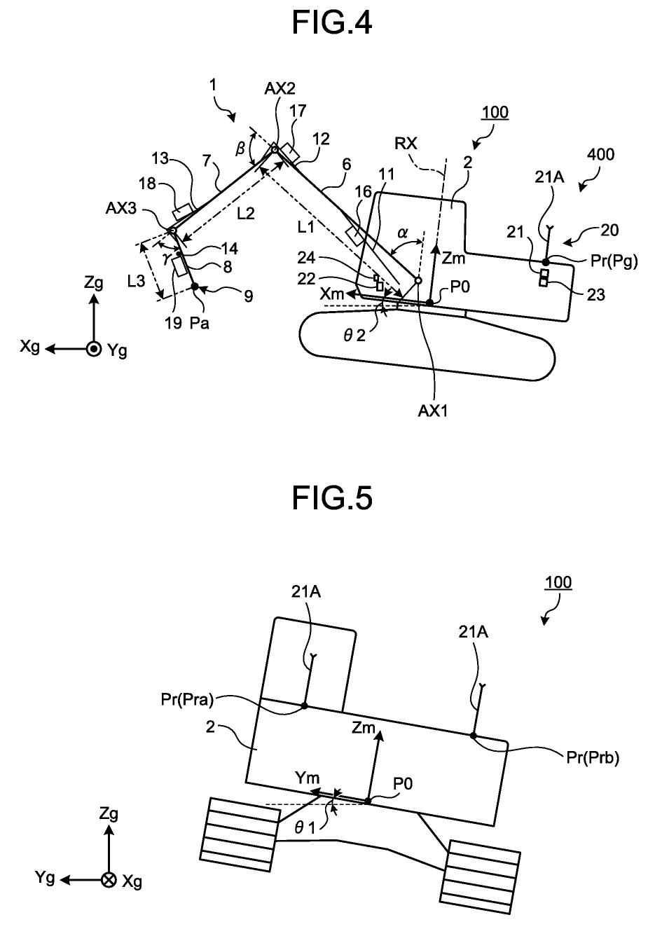

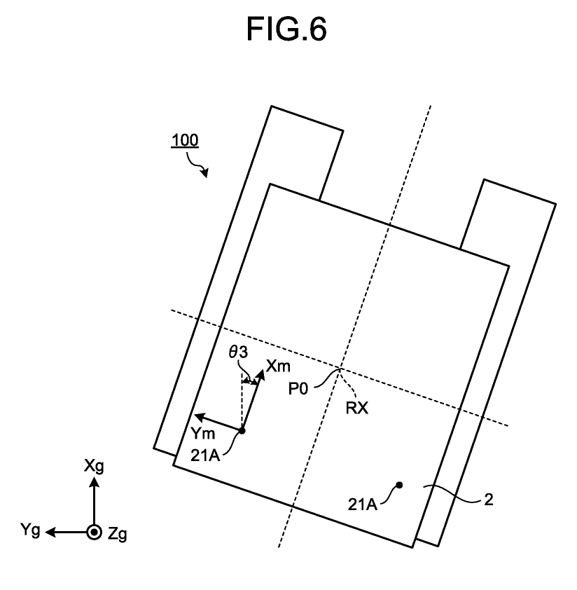

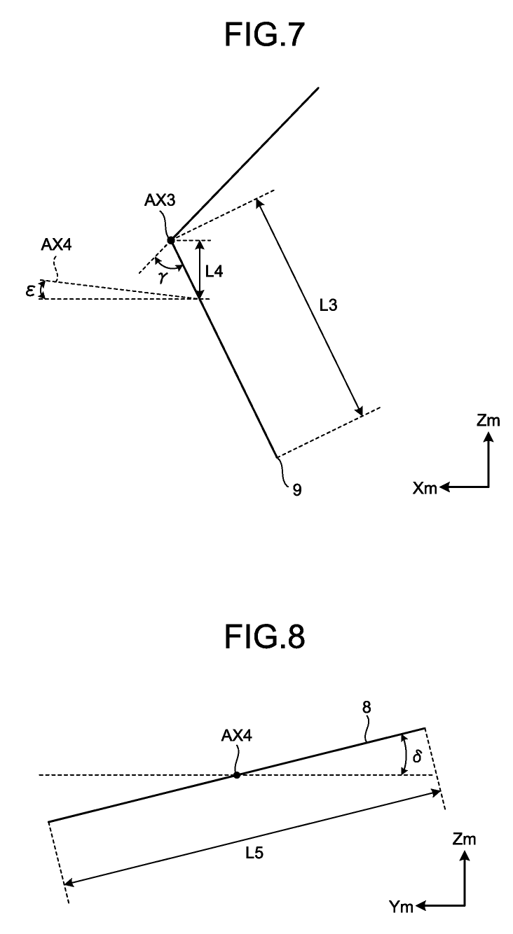

Next, a detection system 400 of the excavator 100 according to this embodiment will be described. FIG. 4 is a side view schematically illustrating the excavator 100 according to this embodiment. FIG. 5 is a rear view schematically illustrating the excavator 100 according to this embodiment. FIG. 6 is a plan view schematically illustrating the excavator 100 according to this embodiment. FIG. 7 is a side view schematically illustrating the bucket 8 according to this embodiment. FIG. 8 is a front view schematically illustrating the bucket 8 according to this embodiment.

As illustrated in FIG. 4, FIG. 5, and FIG. 6, the detection system 400 includes a position calculation device 20 that calculates a position of the upper swing body 2, and a working equipment angle calculation device 24 that calculates an angle of the working equipment 1.

The position calculation device 20 includes a vehicle body position calculator 21 that detects a position of the upper swing body 2, a posture calculator 22 that detects a posture of the upper swing body 2, and an azimuth calculator 23 that detects an azimuth of the upper swing body 2.

The vehicle body position calculator 21 includes a GPS receiver. The vehicle body position calculator 21 is provided in the upper swing body 2. The vehicle body position calculator 21 detects an absolute position Pg of the upper swing body 2 which is defined by the global coordinate system. The absolute position Pg of the upper swing body 2 includes coordinate data in the Xg axis direction, coordinate data in the Yg axis direction, and coordinate data in the Zg axis direction.

A plurality of GPS antennas 21A are provided in the upper swing body 2. Each of the GPS antennas 21A receives electric waves from a GPS satellite, and outputs a signal generated on the basis of the received electric waves to the vehicle body position calculator 21. The vehicle body position calculator 21 detects a position Pr, at which the GPS antenna 21A is provided, defined by the global coordinate system on the basis of the signal supplied from the GPS antenna 21A. The vehicle body position calculator 21 detects the absolute position Pg of the upper swing body 2 on the basis of the position Pr at which the GPS antenna 21A is provided.

Two pieces of the GPS antenna 21A are provided in a vehicle width direction. The vehicle body position calculator 21 detects a position Pra at which the one of the GPS antennas 21A is provided, and a position Prb at which the other GPS antenna 21A is provided. The vehicle body position calculator 21A performs calculation processing on the basis of at least one of the position Pra and the position Prb, and calculates the absolute position Pg of the upper swing body 2. In this embodiment, the absolute position Pg of the upper swing body 2 is the position Pra. Furthermore, the absolute position Pg of the upper swing body 2 may be the position Prb, or may be a position between the position Pra and the position Prb.

The posture calculator 22 includes an inertial measurement unit (IMU). The posture calculator 22 is provided in the upper swing body 2. The posture calculator 22 calculates an inclination angle of the upper swing body 2 with respect to a horizontal plane (XgYg plane) which is defined by the global coordinate system. The inclination angle of the upper swing body 2 with respect to the horizontal plane includes a roll angle θ1 indicating an inclination angle of the upper swing body 2 in the vehicle width direction, and a pitch angle θ2 indicating an inclination angle of the upper swing body 2 in the front and back direction.

The azimuth calculator 23 calculates an azimuth of the upper swing body 2 with respect to a reference azimuth which is defined by the global coordinate system on the basis of the position Pra at which the one GPS antenna 21A is provided and the position Prb at which the other GPS antenna 21A is provided. For example, the reference azimuth is the north. The azimuth calculator 23 performs calculation processing on the basis of the position Pra and the position Prb, and calculates the azimuth of the upper swing body 2 with respect to the reference azimuth. The azimuth calculator 23 calculates a straight line connecting the position Pra and the position Prb, and calculates the azimuth of the upper swing body 2 with respect to the reference azimuth on the basis of an angle made between the calculated straight line and the reference azimuth. The azimuth of the upper swing body 2 with respect to the reference azimuth includes a yaw angle θ3 indicating an angle made between the reference azimuth and the azimuth of the upper swing body 2.

As illustrated in FIG. 4, FIG. 7, and FIG. 8, the working equipment angle calculation device 24 calculates a boom angle α indicating an inclination angle of the boom 6 with respect to the Zm axis of the vehicle body coordinate system on the basis of a boom stroke that is detected by the boom stroke sensor 16. The working equipment angle calculation device 24 calculates an arm angle β indicating an inclination angle of the arm 7 with respect to the boom 6 on the basis of an arm stroke that is detected by the arm stroke sensor 17. The working equipment angle calculation device 24 calculates a bucket angle γ indicating an inclination angle of the blade edge 9 of the bucket 8 with respect to the arm 7 on the basis of a bucket stroke that is detected by the bucket stroke sensor 18. The working equipment angle calculation device 24 calculates a tilt angle δ indicating an inclination angle of the bucket 8 with respect to an XmYm plane of the vehicle body coordinate system on the basis of a tilt stroke that is detected by the tilt stroke sensor 19. The working equipment angle calculation device 24 calculates a tilt axis angle ε indicating an inclination angle of the tilt axis AX4 with respect to the XmYm plane of the vehicle body coordinate system on the basis of the boom stroke that is detected by the boom stroke sensor 16, the arm stroke that is detected by the arm stroke sensor 17, and the tilt stroke that is detected by the bucket stroke sensor 18.

Furthermore, the boom angle α, the arm angle β, the bucket angle γ, the tilt angle δ, and the tilt axis angle ε may be detected by, for example, angle sensors which are provided in the working equipment 10 without using the stroke sensors. In addition, the angle of the working equipment 10 may be optically detected with a stereo camera or a laser scanner, and the boom angle α, the arm angle β, the bucket angle γ, the tilt angle δ, and the tilt axis angle ε may be calculated by using the detection result.

[Hydraulic System]

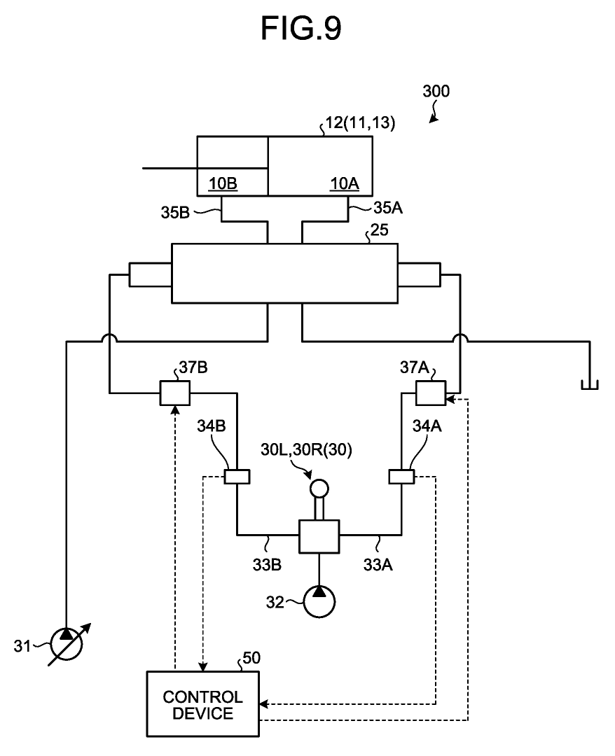

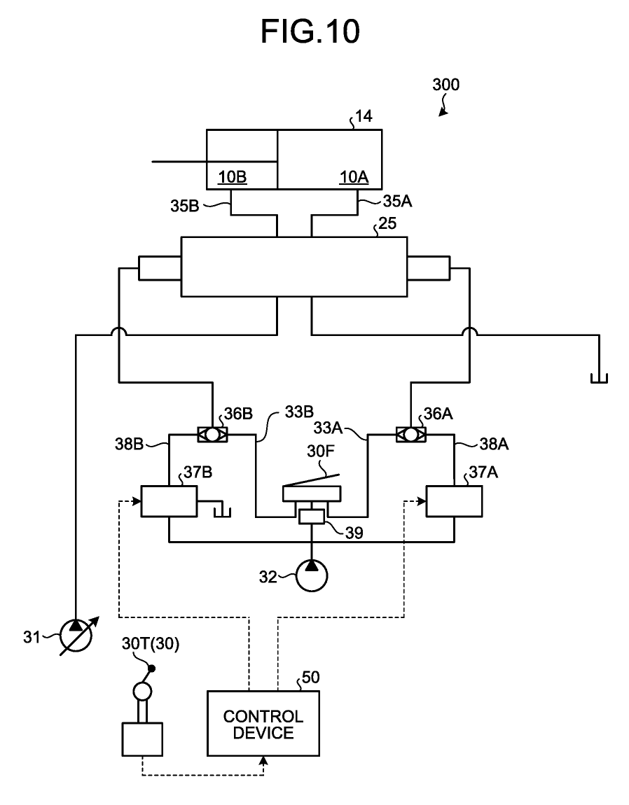

Next, an example of a hydraulic system 300 of the excavator 100 according to this embodiment will be described. FIG. 9 and FIG. 10 are schematic views illustrating an example of the hydraulic system 300 according to this embodiment. The hydraulic cylinder 10 including the boom cylinder 11, the arm cylinder 12, the bucket cylinder 13, and the tilt cylinder 14 is driven by the hydraulic system 300. The hydraulic system 300 supplies a hydraulic oil to the hydraulic cylinder 10 to drive the hydraulic cylinder 10. The hydraulic system 300 includes a flow rate control valve 25. The flow rate control valve 25 controls the amount of the hydraulic oil supplied to the hydraulic cylinder 10, and a direction in which the hydraulic oil flows. The hydraulic cylinder 10 includes a cap side oil chamber 10A and a rod side oil chamber 10B. The cap side oil chamber 10A is a space between a cylinder head cover and a piston. The rod side oil chamber 10B is a space in which a piston rod is disposed. When the hydraulic oil is supplied to the cap side oil chamber 10A through an oil path 35A, the hydraulic cylinder 10 expands. When the hydraulic oil is supplied to the rod side oil chamber 10B through an oil path 35B, the hydraulic cylinder 10 contracts.

FIG. 9 is a schematic view illustrating an example of the hydraulic system 300 that operates the arm cylinder 12. The hydraulic system 300 includes a variable displacement type main hydraulic pump 31 that supplies the hydraulic oil, a pilot pressure pump 32 that supplies a pilot oil, oil paths 33A and 33B through which the pilot oil flows, pressure sensors 34A and 34B which are disposed in the oil paths 33A and 33B, control valves 37A and 37B which adjust a pilot pressure that acts on the flow rate control valve 25, the operation device 30 including the right working equipment operation lever 30R and the left working equipment operation lever 30L which adjust the pilot pressure with respect to the flow rate control valve 25, and the control device 50. The right working equipment operation lever 30R and the left working equipment operation lever 30L of the operation device 30 are pilot hydraulic type operation devices.

The hydraulic oil supplied from the main hydraulic pump 31 is supplied to the arm cylinder 12 through the flow rate control valve 25. The flow rate control valve 25 is a slide spool type flow rate control valve that switches a flow direction of the hydraulic oil by moving a rod-shaped spool in an axial direction. When the spool is moved in the axial direction, supply of the hydraulic oil to the cap side oil chamber 10A of the arm cylinder 12 and supply of the hydraulic oil to the rod side oil chamber 10B are switched from each other. In addition, when the spool is moved in the axial direction, the supply amount of the hydraulic oil per unit time with respect to the arm cylinder 12 is adjusted. When the supply amount of the hydraulic oil with respect to the arm cylinder 12 is adjusted, a cylinder speed is adjusted.

The flow rate control valve 25 is operated by the operation device 30. The pilot oil sent from the pilot pressure pump 32 is supplied to the operation device 30. Furthermore, a pilot oil, which is sent from the main hydraulic pump 31 and of which a pressure is reduced by a pressure reduction valve, may be supplied to the operation device 30. The operation device 30 includes a pilot pressure adjustment valve. The control valves 37A and 37B are operated on the basis of an operation amount of the operation device 30, and a pilot pressure that acts on the spool of the flow rate control valve 25 is adjusted. The flow rate control valve 25 is driven by the pilot pressure. When the pilot pressure is adjusted by the operation device 30, the amount of movement, a movement speed, and a movement direction of the spool in an axial direction are adjusted.

The flow rate control valve 25 includes a first pressure-receiving chamber and a second pressure-receiving chamber. When the left working equipment operation lever 30L is operated to be tilted to one side in comparison to a neutral position, and the spool is moved by the pilot pressure of the oil path 33A, the hydraulic oil from the main hydraulic pump 31 is supplied to the first pressure-receiving chamber, and the hydraulic oil is supplied to the cap side oil chamber 10A through the oil path 35A. When the left working equipment operation lever 30L is operated to be tilted to the other side in comparison to the neutral position, and the spool is moved by the pilot pressure of the oil path 33B, the hydraulic oil from the main hydraulic pump 31 is supplied to the second pressure-receiving chamber, and the hydraulic oil is supplied to the rod side oil chamber 10B through the oil path 35B.

The pressure sensor 34A detects a pilot pressure of the oil path 33A. The pressure sensor 34B detects a pilot pressure of the oil path 33B. A detection signal of the pressure sensor 33A or 33B is output to the control device 50. When performing intervention control, the control device 50 outputs a control signal to the control valve 37A or 37B to adjust the pilot pressure.

A hydraulic system 300 that operates the boom cylinder 11 and the bucket cylinder 13 has the same configuration as that of the hydraulic system 300 that operates the arm cylinder 12. Detailed description of the hydraulic system 300 that operates the boom cylinder 11 and the bucket cylinder 13 will be omitted. Furthermore, an intervention control valve that intervenes in a lifting operation of the boom 6 may be connected to the oil path 33A that is connected to the boom cylinder 11 to perform intervention control with respect to the boom 6.

Furthermore, the right working equipment operation lever 30R and the left working equipment operation lever 30L of the operation device 30 may not be the pilot hydraulic type. The right working equipment operation lever 30R and the left working equipment operation lever 30L may be an electronic lever type that outputs an electric signal to the control device 50 on the basis of an operation amount (a tilt angle) of the right working equipment operation lever 30R and the left working equipment operation lever 30L, and directly controls the flow rate control valve 25 on the basis of a control signal of the control device 50.

FIG. 10 is a view schematically illustrating an example of a hydraulic system 300 that operates the tilt cylinder 14. The hydraulic system 300 includes the flow rate control valve 25 that adjusts the amount of the hydraulic oil supplied to the tilt cylinder 14, the control valves 37A and 37B which adjust the pilot pressure that acts on the flow rate control valve 25, a control valve 39 that is disposed between the pilot pressure pump 32 and the operation pedal 30F, the tilt operation lever 30T and the operation pedal 30F of the operation device 30, and the control device 50. In this embodiment, the operation pedal 30F of the operation device 30 is a pilot hydraulic type operation device. The tilt operation lever 30T of the operation device 30 is an electronic lever type operation device. The tilt operation lever 30T includes operation buttons which are provided in the right working equipment operation lever 30R and the left working equipment operation lever 30L.

The operation pedal 30F of the operation device 30 is connected to the pilot pressure pump 32. In addition, the operation pedal 30F is connected to an oil path 38A, through which a pilot oil sent from the control valve 37A flows, through a shuttle valve 36A. In addition, the operation pedal 30F is connected to an oil path 38B, through which a pilot oil sent from the control valve 37B flows, through a shuttle valve 36B. When the operation pedal 30F is operated, a pressure of an oil path 33A between the operation pedal 30F and the shuttle valve 36A, and a pressure of an oil path 33B between the operation pedal 30F and the shuttle valve 36B are adjusted.

When the tilt operation lever 30T is operated, an operation signal generated by the operation of the tilt operation lever 30T is output to the control device 50. The control device 50 generates a control signal on the basis of the operation signal output from the tilt operation lever 30T to control the control valves 37A and 37B. The control valves 37A and 37B are electromagnetic proportional control valves. The control valve 37A opens and closes the oil path 38A on the basis of the control signal. The control valve 37B opens and closes the oil path 38B on the basis of the control signal.

When not performing the intervention control with respect to tilt rotation of the bucket 8, the pilot pressure is adjusted on the basis of an operation amount of the operation device 30. When performing the intervention control with respect to the tilt rotation of the bucket 8, the control device 50 outputs the control signal to the control valve 37A or 37B to adjust the pilot pressure.

[Control System]

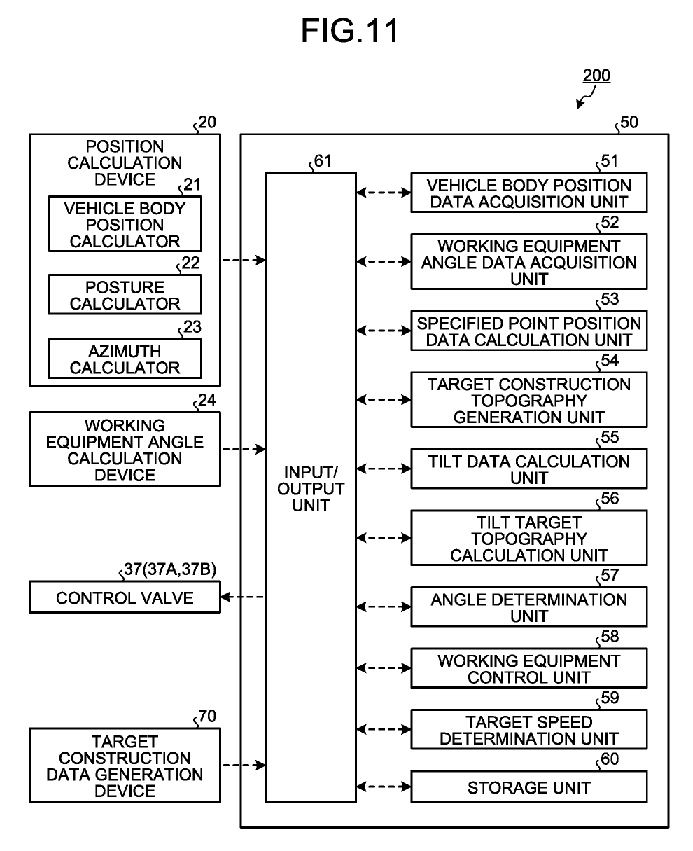

Next, a control system 200 of the excavator 100 according to this embodiment will be described. FIG. 11 is a functional block diagram illustrating an example of the control system 200 according to this embodiment.

As illustrated in FIG. 11, the control system 200 includes the control device 50 that controls the working equipment 1, the position calculation device 20, the working equipment angle calculation device 24, the control valves 37 (37A and 37B), and a target construction data generation device 70.

The position calculation device 20 includes a vehicle body position calculator 21, a posture calculator 22, and an azimuth calculator 23. The position calculation device 20 detects the absolute position Pg of the upper swing body 2, the posture of the upper swing body 2 which includes the roll angle θ1 and the pitch angle θ2, and the azimuth of the upper swing body 2 which includes the yaw angle θ3.

The working equipment angle calculation device 24 detects the angle of the working equipment 1 which includes the boom angle α, the arm angle β, the bucket angle γ, the tilt angle δ, and the tilt axis angle ε.

The control valves 37 (37A and 37B) adjust the amount of the hydraulic oil supplied to the tilt cylinder 14. The control valves 37 operate on the basis of the control signal from the control device 50.

The target construction data generation device 70 includes a computer system. The target construction data generation device 70 generates target construction data indicating a target topography that is a target shape of a construction area. The target construction data indicates a three-dimensional target shape that is obtained after construction by the working equipment 1.

The target construction data generation device 70 is provided at a remote location of the excavator 100. For example, the target construction data generation device 70 is provided in a facility of a construction management company. Furthermore, the target construction data generation device 70 may be possessed by a manufacturing company or a rental company of the excavator 100. The target construction data generation device 70 and the control device 50 can perform wireless communication. The target construction data generated by the target construction data generation device 70 is wirelessly transmitted to the control device 50.

Furthermore, the target construction data generation device 70 and the control device 50 may be connected with a wire, and the target construction data may be transmitted from the target construction data generation device 70 to the control device 50. Furthermore, the target construction data generation device 70 may include a recording medium that stores the target construction data, and the control device 50 may include a device that can scan the target construction data from the recording medium.

Furthermore, the target construction data generation device 70 may be provided in the excavator 100. The target construction data may be supplied from an external management device that manages construction to the target construction data generation device 70 of the excavator 100 in a wired or wireless manner, and the target construction data generation device 70 may store the target construction data that is supplied.

The control device 50 includes a vehicle body position data acquisition unit 51, a working equipment angle data acquisition unit 52, a specified point position data calculation unit 53, a target construction topography generation unit 54, a tilt data calculation unit 55, a tilt target topography calculation unit 56, an angle determination unit 57, a working equipment control unit 58, a target speed determination unit 59, a storage unit 60, and an input/output unit 61.

Respective functions of the vehicle body position data acquisition unit 51, the working equipment angle data acquisition unit 52, the specified point position data calculation unit 53, the target construction topography generation unit 54, the tilt data calculation unit 55, the tilt target topography calculation unit 56, the angle determination unit 57, the working equipment control unit 58, and the target speed determination unit 59 are exhibited by a processor of the control device 50. A function of the storage unit 60 is exhibited by the storage device of the control device 50. A function of the input/output unit 61 is exhibited by the input/output interface device of the control device 50. The input/output unit 61 is connected to the position calculation device 20, the working equipment angle calculation device 24, the control valves 37, and the target construction data generation device 70, and performs data communication with the vehicle body position data acquisition unit 51, the working equipment angle data acquisition unit 52, the specified point position data calculation unit 53, the target construction topography generation unit 54, the tilt data calculation unit 55, the tilt target topography calculation unit 56, the angle determination unit 57, the working equipment control unit 58, the target speed determination unit 59, and the storage unit 60.

The storage unit 60 stores parameter data of the excavator 100 which includes the working equipment data.

The vehicle body position data acquisition unit 51 acquires vehicle body position data from the position calculation device 20 through the input/output unit 61. The vehicle body position data includes the absolute position Pg of the upper swing body 2 which is defined by the global coordinate system, the posture of the upper swing body 2 which includes the roll angle θ1 and the pitch angle θ2, and the azimuth of the upper swing body 2 which includes the yaw angle θ3.

The working equipment angle data acquisition unit 52 acquires the working equipment angle data from the working equipment angle calculation device 24 through the input/output unit 61. The working equipment angle data detects an angle of the working equipment 1 which includes the boom angle α, the arm angle β, the bucket angle γ, the tilt angle δ, and the tilt axis angle E.

The specified point position data calculation unit 53 calculates position data of specified point RP that is set to the bucket 8 on the basis of the vehicle body position data acquired by the vehicle body position data acquisition unit 51, the working equipment angle data acquired by the working equipment angle data acquisition unit 52, and the working equipment data stored in the storage unit 60.

As illustrated in FIG. 4 and FIG. 7, the working equipment data includes a boom length L1, an arm length L2, a bucket length L3, a tilt length L4, and a bucket width L5. The boom length L1 is a distance between the boom axis AX1 and the arm axis AX2. The arm length L2 is a distance between the arm axis AX2 and the bucket axis AX3. The bucket length L3 is a distance between the bucket axis AX3 and the blade edge 9 of the bucket 8. The tilt length L4 is a distance between the bucket axis AX3 and the tilt axis AX4. The bucket width L5 is a distance between the side plate 84 and the side plate 85.

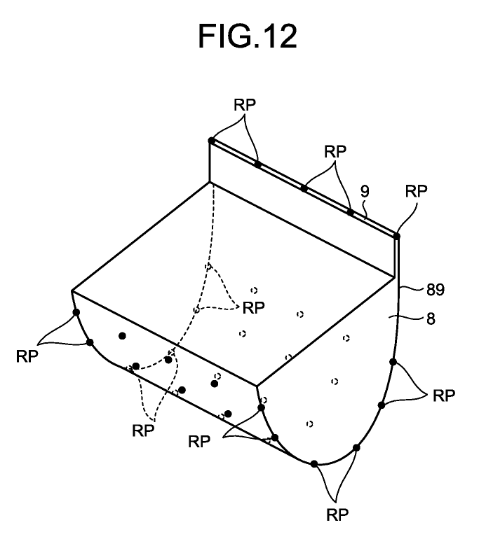

FIG. 12 is a view schematically illustrating an example of the specified point RP that is set to the bucket 8 according to this embodiment. As illustrated in FIG. 12, a plurality of the specified points RP which are used in tilt bucket control are set in the bucket 8. The specified points RP are set to an outer surface of the bucket 8 which includes the blade edge 9 and the floor surface 89 of the bucket 8. The plurality of specified points RP are set to the blade edge 9 in a bucket width direction. In addition, the plurality of specified points RP are set to the outer surface of the bucket 8 which includes the floor surface 89.

In addition, the working equipment data includes bucket outer shape data indicating a shape and dimensions of the bucket 8. The bucket outer shape data includes width data of the bucket 8 which indicates the bucket width L5. In addition, the bucket outer shape data includes outer surface data of the bucket 8 which includes contour data of the outer surface of the bucket 8. In addition, the bucket outer shape data includes coordinate data of the plurality of specified points RP of the bucket 8 with the blade edge 9 of the bucket 8 set as a reference.

The specified point position data calculation unit 53 calculates position data of the specified points RP. The specified point position data calculation unit 53 calculates a relative position of each of the plurality of specified points RP with respect to a reference position P0 of the upper swing body 2 in the vehicle body coordinate system. In addition, the specified point position data calculation unit 53 calculates an absolute position of each of the plurality of specified points RP in the global coordinate system.

The specified point position data calculation unit 53 can calculate a relative position of each of the plurality of specified points RP of the bucket 8 with respect to the reference position P0 of the upper swing body 2 in the vehicle body coordinate system on the basis of the working equipment data that includes the boom length L1, the arm length L2, the bucket length L3, the tilt length L4, and the bucket outer shape data, and the working equipment angle data that includes the boom angle α, the arm angle β, the bucket angle γ, the tilt angle δ, and the tilt axis angle ε. As illustrated in FIG. 4, the reference position P0 of the upper swing body 2 is set to the swing axis RX of the upper swing body 2. Furthermore, the reference position P0 of the upper swing body 2 may be set to the boom axis AX1.

In addition, the specified point position data calculation unit 53 can calculate the absolute position Pa of the bucket 8 in the global coordinate system on the basis of the absolute position Pg of the upper swing body 2 which is detected by the position calculation device 20, and a relative position between the reference position P0 of the upper swing body 2 and the bucket 8. The absolute position Pg and the relative position with the reference position P0 are known data that is derived from parameter data of the excavator 100. The specified point position data calculation unit 53 can calculate an absolute position of each of the plurality of specified points RP of the bucket 8 in the global coordinate system on the basis of the vehicle body position data including the absolute position Pg of the upper swing body 2, the relative position between the reference position P0 of the upper swing body 2 and the bucket 8, the working equipment data, and the working equipment angle data.

The target construction topography generation unit 54 generates a target construction topography CS indicating a target shape of an excavation object on the basis of the target construction data that is supplied from the target construction data generation device 70 and is stored in the storage unit 60. The target construction data generation device 70 may supply three-dimensional topography data to the target construction topography generation unit 54, or may supply a plurality of pieces of line data or a plurality of pieces of point data which indicate a part of the target shape to the target construction topography generation unit 54 as the target construction data. In this embodiment, it is assumed that the target construction data generation device 70 supplies line data indicating a part of the target shape to the target construction topography generation unit 54 as the target construction data.

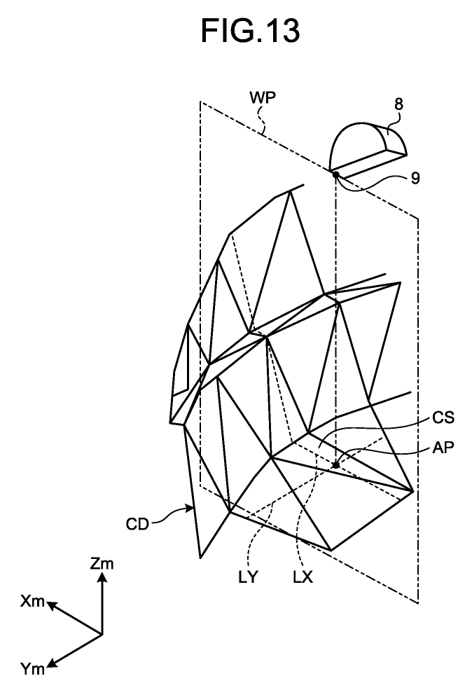

FIG. 13 is a schematic view illustrating an example of target construction data CD according to this embodiment. As illustrated in FIG. 13, the target construction data CD indicates a target topography of a construction area. The target topography includes a plurality of target construction topographies CS which are expressed by a triangular polygon. Each of the plurality of target construction topographies CS indicates a target shape of an object to be excavated by the working equipment 1. In the target construction data CD, among the target construction topographies CS, a point AP at which a vertical distance to the bucket 8 is the shortest is specified. In addition, in the target construction data CD, a working equipment operation plane WP that passes through the point AP and the bucket 8 and is orthogonal to the bucket axis AX3 is specified. The working equipment operation plane WP is an operation plane on which the blade edge 9 of the bucket 8 is moved by an operation of at least one of the boom cylinder 11, the arm cylinder 12, and the bucket cylinder 13, and is parallel to an XZ plane. The specified point position data calculation unit 53 calculates position data of the specified point RP at which the vertical distance to the point AP of each of the target construction topographies CS is specified to be shortest on the basis of the target construction topography CS and the outer shape data of the bucket 8. When obtaining the specified point RP, data related to at least the width of the bucket 8 may be used. In addition, the specified point RP may be designated by an operator.

The target construction topography generation unit 54 acquires a line LX that is an intersecting line between the working equipment operation plane WP and the target construction topography CS. In addition, the target construction topography generation unit 54 acquires a line LY that passes through the point AP and is orthogonal to the line LX in the target construction topography CS. The line LY represents an intersecting line between a lateral operation plane VP and the target construction topography CS. The lateral operation plane VP is a plane that is orthogonal to the working equipment operation plane WP and passes through the point AP.

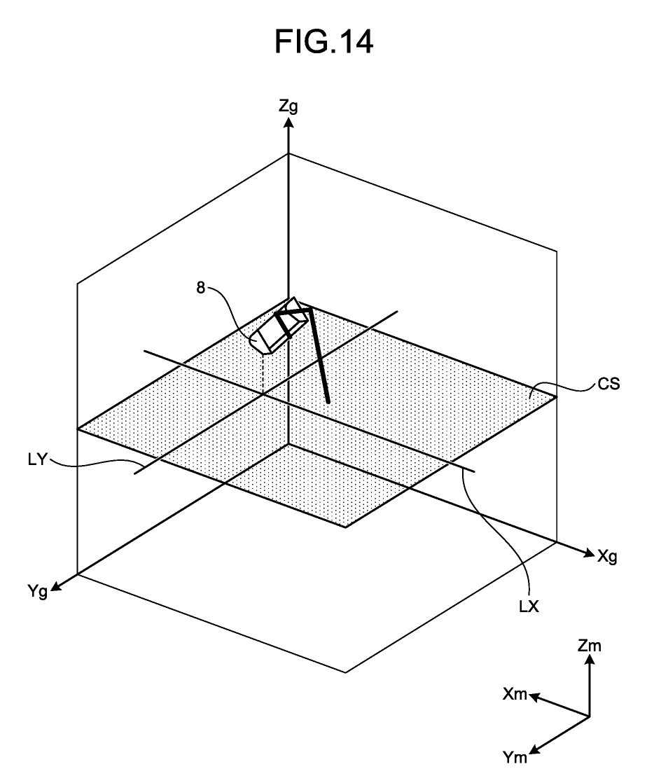

FIG. 14 is a schematic view illustrating an example of the target construction topography CS according to this embodiment. The target construction topography generation unit 54 acquires the line LX and the line LY, and generates the target construction topography CS indicating the target shape of an excavation target on the basis of the line LX and the line LY. In a case of excavating the target construction topography CS by the bucket 8, the control device 50 moves the bucket 8 along the line LX that is an intersecting line between the working equipment operation plane WP that passes through the bucket 8, and the target construction topography CS.

The tilt data calculation unit 55 calculates a tilt operation plane TP that passes through the specified point RP of the bucket 8 and is orthogonal to the tilt axis AX4 as tilt data.

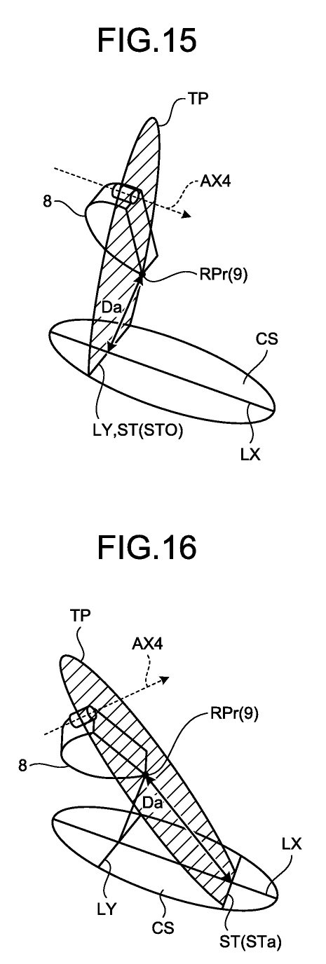

FIG. 15 and FIG. 16 are schematic views illustrating an example of the tilt operation plane TP according to this embodiment. FIG. 15 illustrates the tilt operation plane TP when the tilt axis AX4 is parallel to the target construction topography CS. FIG. 16 illustrates the tilt operation plane TP when the tilt axis AX4 is not parallel to the target construction topography CS.

As illustrated in FIG. 15 and FIG. 16, the tilt operation plane TP represents an operation plane that passes through a specified point RPr selected from a plurality of specified points RP which are specified to the bucket 8, and is orthogonal to the tilt axis AX4. As the specified point RPr, among the plurality of specified points RP, a specified point RP at which a distance to the target construction topography CS is shortest is selected.

FIG. 15 and FIG. 16 illustrate a tilt operation plane TP that passes through a specified point RPr set to the blade edge 9 as an example. The tilt operation plane TP is an operation plane on which the specified point RPr (the blade edge 9) of the bucket 8 is moved due to an operation of the tilt cylinder 14. When at least one of the boom cylinder 11, the arm cylinder 12, and the bucket cylinder 13 operates, and the tilt axis angle ε indicating a direction of the tilt axis AX4 varies, an inclination of the tilt operation plane TP also varies.

As described above, the working equipment angle calculation device 24 can calculate the tilt axis angle ε indicating the inclination angle of the tilt axis AX4 with respect to the XY plane. The tilt axis angle ε is acquired by the working equipment angle data acquisition unit 52. In addition, position data of the specified point RPr is calculated by the specified point position data calculation unit 53. The tilt data calculation unit 55 can calculate the tilt operation plane TP on the basis of the tilt axis angle ε of the tilt axis AX4 which is acquired by the working equipment angle data acquisition unit 52, and the position of the specified point RPr which is calculated by the specified point position data calculation unit 53.

The tilt target topography calculation unit 56 calculates a tilt target topography ST that extends in a lateral direction of the bucket 8 in the target construction topography CS on the basis of the position data of the specified point RPr selected from the plurality of specified points RP, the target construction topography CS, and the tilt data. The tilt target topography calculation unit 56 calculates the tilt target topography ST that is specified by an intersection between the target construction topography CS and the tilt operation plane TP. As illustrated in FIG. 15 and FIG. 16, the tilt target topography ST is expressed by an intersection line between the target construction topography CS and the tilt operation plane TP. When the tilt axis angle ε that is the direction of the tilt axis AX4 varies, the position of the tilt target topography ST varies.

The angle determination unit 57 determines the tilt angle δ indicating an angle of a specific portion of the bucket 8 around the tilt axis AX4 so that the target construction topography CS and the specific portion of the bucket 8 become parallel to each other. In this embodiment, the specific portion of the bucket 8 is the blade edge 9 of the bucket 8.

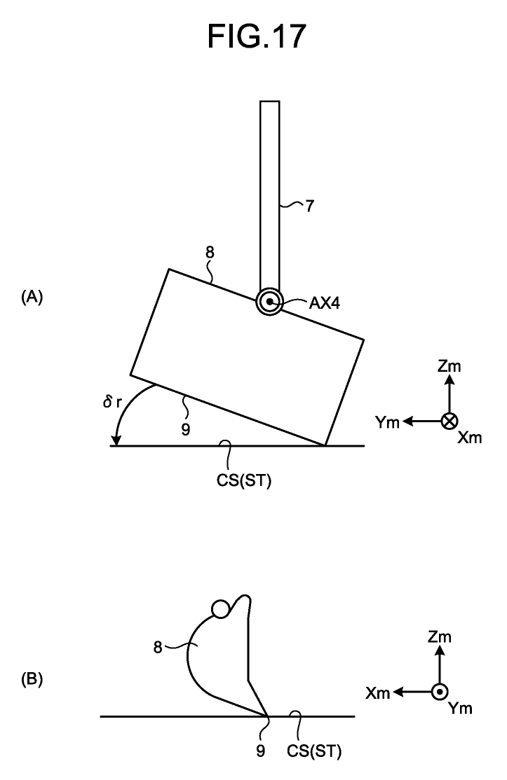

FIG. 17 is a view schematically illustrating a relationship between the blade edge 9 of the bucket 8 and the target construction topography CS according to this embodiment. FIG. 17(A) is a view when the bucket 8 is seen from a −Xm side. FIG. 17(B) is a view when the bucket 8 is seen from +Ym side. As illustrated in FIG. 17, the angle determination unit 57 determines a tilt angle δr indicating an angle of the blade edge 9 of the bucket 8 around the tilt axis AX4 so that the target construction topography CS and the blade edge 9 of the bucket 8 become parallel to each other. That is, the angle determination unit 57 determines a tilt rotation angle δr of the blade edge 9 of the bucket 8 in a tilt rotation direction to make the blade edge 9 of the bucket 8 parallel to the target construction topography CS.

In this embodiment, the angle determination unit 57 determines the tilt angle δr of the blade edge of the bucket 8 so that the tilt target topography ST becomes parallel to the blade edge 9 of the bucket 8.

The working equipment control unit 58 outputs a control signal for controlling the hydraulic cylinder 10. The working equipment control unit 58 controls the tilt cylinder 14 so that the target construction topography CS and the blade edge 9 of the bucket 8 become parallel to each other on the basis of the tilt angle δr determined by the angle determination unit 57.

In addition, the working equipment control unit 58 stops the tilt rotation of the bucket 8 around the tilt axis AX4 so that the bucket 8 does not exceed the target construction topography CS on the basis of an operation distance Da indicating a distance between the specified point RPr of the bucket 8 and the tilt target topography ST. That is, the working equipment control unit 58 stops the bucket 8 in the tilt target topography ST so that the bucket 8 that tilt-rotates does not exceed the tilt target topography ST.

As illustrated in FIG. 15, when the tilt axis AX4 is parallel to the target construction topography CS, the tilt target topography ST and the line LY approximately match each other. Accordingly, intervention control related to the tilt rotation with the tilt target topography ST set as a reference, and intervention control related to the tilt rotation with the line LY set as a reference are substantially the same as each other.

The working equipment control unit 58 performs the intervention control related to the tilt rotation on the basis of the specified point RPr at which the operation distance Da is shortest among the plurality of specified points RP set to the bucket 8. That is, the working equipment control unit 58 performs the intervention control related to the tilt rotation on the basis of the specified point RPr closest to the tilt target topography ST, the tilt target topography ST, and the operation distance Da so that the specified point RPr closest to the tilt target topography ST among the plurality of specified points RP set to the bucket 8 does not exceed the tilt target topography ST.

The target speed determination unit 59 determines a target speed U related to a tilt rotation speed of the bucket 8 on the basis of the operation distance Da. When the operation distance Da is equal to or shorter than a line distance H that is a threshold value, the target speed determination unit 59 limits the tilt rotation speed.

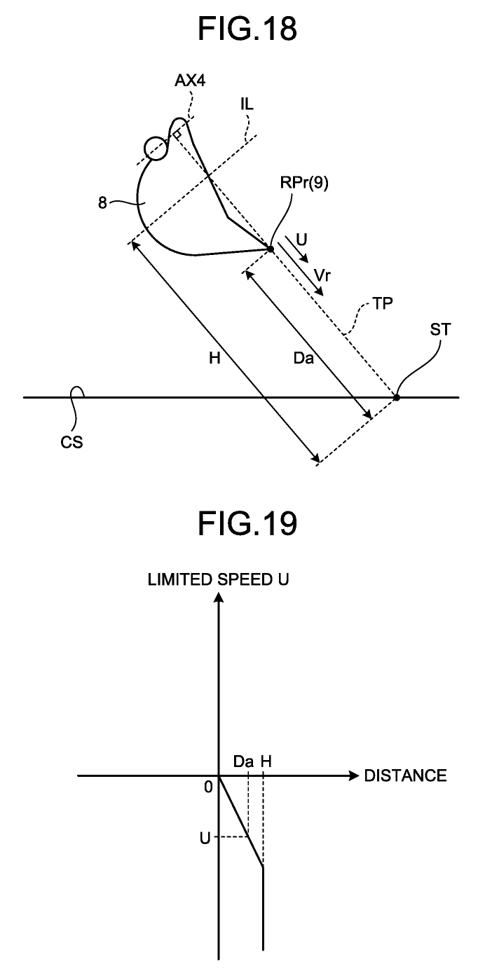

FIG. 18 is a schematic view illustrating the intervention control related to the tilt rotation according to this embodiment. As illustrated in FIG. 18, the target construction topography CS is specified, and a speed limiting intervention line IL is specified. The speed limiting intervention line IL is parallel to the tilt axis AX4, and is specified to a position that is spaced away from the tilt target topography ST by a line distance H. It is preferable that the line distance H is set so that an operation sense of the operator is not damaged. When at least a part of the bucket 8 that tilt-rotates exceeds the speed limiting intervention line IL, and the operation distance Da is equal to or shorter than the line distance H, the working equipment control unit 58 limits the tilt rotation speed of the bucket 8. The target speed determination unit 59 determines the target speed U related to the tilt rotation speed of the bucket 8 that exceeds the speed limiting intervention line IL. In the example illustrated in FIG. 18, since a part of the bucket 8 exceeds the speed limiting intervention line IL, and the operation distance Da is shorter than the line distance H, the tilt rotation speed is limited.

The target speed determination unit 59 acquires the operation distance Da between the specified point RPr and the tilt target topography ST in a direction parallel to the tilt operation plane TP. In addition, the target speed determination unit 59 acquires the target speed U corresponding to the operation distance Da. In a case where it is determined that the operation distance Da is equal to or shorter than the line distance H, the working equipment control unit 58 limits the tilt rotation speed.

FIG. 19 is a view illustrating an example of a relationship between the operation distance Da and the target speed U according to this embodiment. FIG. 19 illustrates an example of a relationship between the operation distance Da and the target speed U for stopping the tilt rotation of the bucket 8 on the basis of the operation distance Da. As illustrated in FIG. 19, the target speed U is a speed that is determined in a uniform manner in correspondence with the operation distance Da. The target speed U is not set when the operation distance Da is longer than the line distance H, and is set when the operation distance Da is equal to or shorter than the line distance H. The shorter the operation distance Da is, the slower the target speed U is. Accordingly, when the operation distance Da becomes 0, the target speed U also becomes 0. Furthermore, in FIG. 19, a direction of approaching the target construction topography CS is illustrated as a negative direction.

The target speed determination unit 59 calculates a movement speed Vr when the specified point RP moves toward the target construction topography CS (tilt target topography ST) on the basis of the operation amount of the tilt operation lever 30T of the operation device 30. The movement speed Vr is a movement speed of the specified point RPr in a plane parallel to the tilt operation plane TP. The movement speed Vr is calculated with respect to each of the plurality of specified points RP.

In this embodiment, in a case where the tilt operation lever 30T is operated, the movement speed Vr is calculated on the basis of a current value output from the tilt operation lever 30T. When the tilt operation lever 30T is operated, a current corresponding to an operation amount of the tilt operation lever 30T is output from the tilt operation lever 30T. The storage unit 60 can store a cylinder speed of the tilt cylinder 14 corresponding to the operation amount of the tilt operation lever 30T. Furthermore, the cylinder speed may be obtained through detection by a cylinder stroke sensor. After the cylinder speed of the tilt cylinder 14 is calculated, the target speed determination unit 59 converts the cylinder speed of the tilt cylinder 14 into the movement speed Vr of each of the plurality of specified point RP of the bucket 8 by using a Jacobian determinant.

In a case where it is determined that the operation distance Da is equal to or shorter than the line distance H, the working equipment control unit 58 performs speed limitation that limits the movement speed Vr of the specified point RPr with respect to the target construction topography CS to the target speed U. The working equipment control unit 58 outputs a control signal to the control valves 37 to suppress the movement speed Vr of the specified point RPr of the bucket 8. The working equipment control unit 58 outputs a control signal to the control valves 37 so that the movement speed Vr of the specified point RPr of the bucket 8 becomes the target speed U corresponding to the operation distance Da. According to this, the movement speed RP of the specified point RPr of the bucket 8 that tilt-rotates becomes slower as the specified point RPr approaches the target construction topography CS (tilt target topography ST), and becomes 0 when the specified point RPr (blade edge 9) reaches the target construction topography CD.

[Angle Adjustment Method]

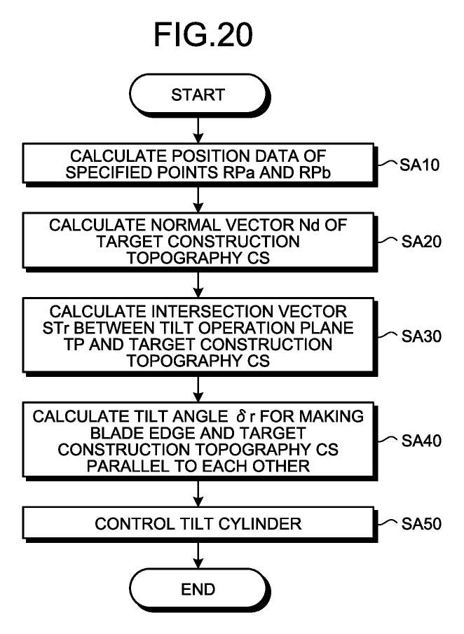

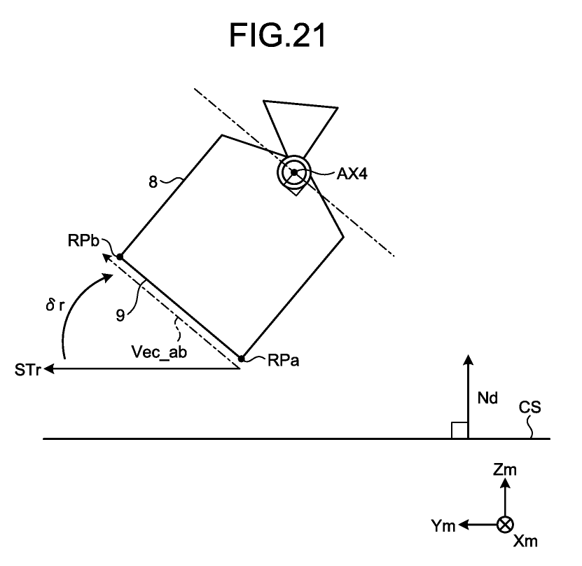

Next, a method of adjusting the tilt angle δ of the bucket 8 according to this embodiment will be described. FIG. 20 is a flowchart illustrating an example of the method of adjusting the tilt angle δ of the bucket 8 according to this embodiment. FIG. 21 is a schematic view illustrating an example of the method of adjusting the tilt angle δ of the bucket 8 according to this embodiment.

The specified point position data calculation unit 53 calculates position data of a specified point RPa that is specified to the blade edge 9, and position data of a specified point RPb that is specified to the blade edge 9 (Step SA10).

As illustrated in FIG. 21, the specified point RPa and the specified point RPb are specified points on both sides in a width direction of the bucket 8 in the blade edge 9. The specified point position data calculation unit 53 calculates position data of the specified point RPa and position data of the specified point RPb in the vehicle body coordinate system.

In addition, the specified point position data calculation unit 53 calculates a direction vector Vec_ab that connects the specified point RPa and the specified point RPb on the basis of the position data of the specified point RPa and the position data of the specified point RPb. The direction vector Vec_ab is defined by the following Expression (1).

Vec_ab=RPb−RPa (1)

The target construction topography generation unit 54 calculates a normal vector Nd of the target construction topography CS (Step SA20).

The angle determination unit 57 calculates an intersection vector STr between the tilt operation plane TP and the target construction topography CS (Step SA30).

The angle determination unit 57 calculates the tilt angle δr of the blade edge 9 of the bucket 8 for making the blade edge 9 of the bucket 8 and the target construction topography CS parallel to each other (Step SA40).

In this embodiment, the angle determination unit 57 performs calculation processing of the following Expression (2) to calculate the tilt angle δr.

$$δ r = {cos}^{- 1} ( \frac{STr \cdot Vec\_ab}{\vert STr \vert \vert Vec\_ab \vert} ) \qquad ( 2 )$$

The working equipment control unit 58 controls the tilt cylinder 14 so that the target construction topography CS and the blade edge 9 of the bucket 8 become parallel to each other on the basis of the tilt angle δr determined by the angle determination unit 57 (Step SA50).

[Effects]

As described above, according to this embodiment, in the tilt type bucket, the tilt angle δr of the blade edge 9 of the bucket 8 around the tilt axis AX4 is determined in the angle determination unit 57 so that the target construction topography CS and the blade edge 9 of the bucket 8 become parallel to each other on the basis of a relative angle of the blade edge 9 of the bucket 8 with respect to the target construction topography CS. The working equipment control unit 58 controls the tilt cylinder 14 that rotates the bucket 8 around the tilt axis AX4 on the basis of the tilt angle δr that is determined by the angle determination unit 57. According to this, it is possible to make the blade edge 9 of the bucket 8 and the target construction topography CS parallel to each other in the tilt rotation direction. Accordingly, an operation burden on an operator of the excavator 1 is reduced in construction, and a high-quality construction result that does not depend on the degree of skill of the operator is obtained.

### Second Embodiment

A second embodiment will be described. In the following description, the same reference numeral will be given to the same constituent elements or equivalent constituent elements, and description thereof will be simplified or omitted.

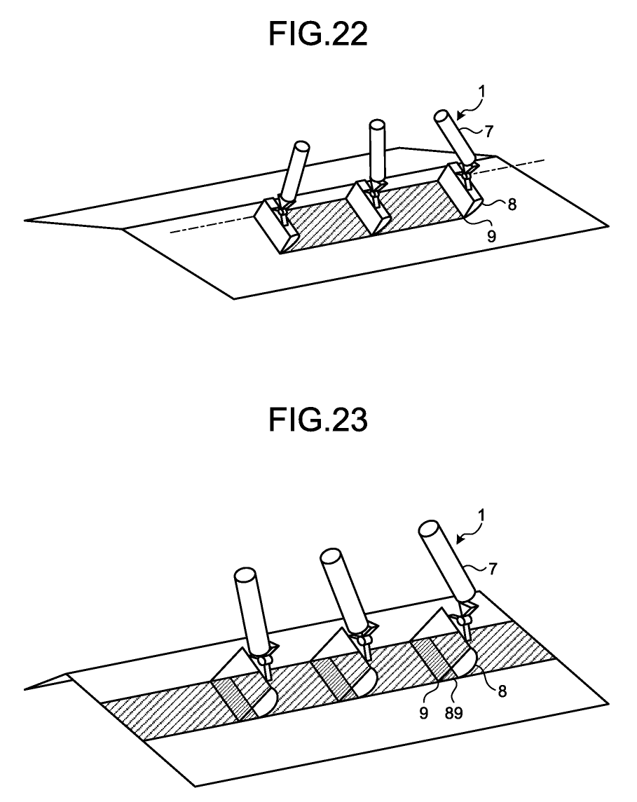

FIG. 22 and FIG. 23 are views schematically illustrating an example of an operation of working equipment 1 according to this embodiment. FIG. 22 and FIG. 23 illustrate an example in which construction is performed on the basis of an inclined target construction topography CS by using the working equipment 1 including the tilt type bucket 8.

As illustrated in FIG. 22, in some cases, it is desired to perform construction while moving the arm 7 in a state in which the blade edge 9 of the bucket 8 and the target construction topography CS are made to match each other by making the blade edge 9 and the target construction topography CS parallel to each other. In addition, as illustrated in FIG. 23, in some cases, it is desired to perform construction while moving the arm 7 in a state in which the floor surface 89 and the target construction topography CS are made to match each other by making the floor surface 89 of the bucket 8 and the target construction topography CS parallel to each other.

In this embodiment, description will be given of an example in which the working equipment control unit 58 controls at least one of the tilt cylinder 14 and the bucket cylinder 13 so that parallelism between at least one of the blade edge 9 of the bucket 8 and the floor surface 89 and the target construction topography CS is maintained in a state in which the arm 7 operates.

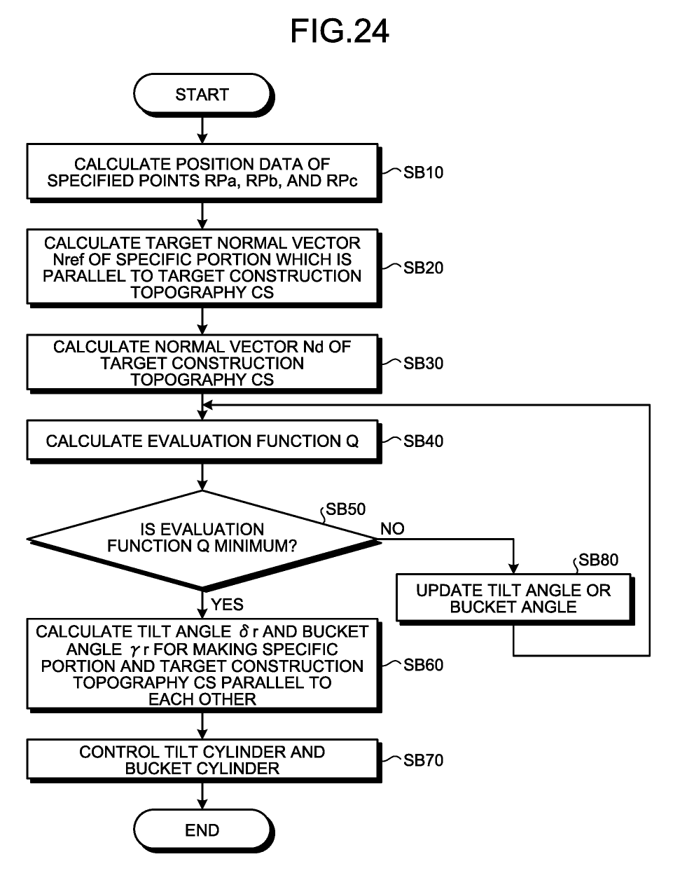

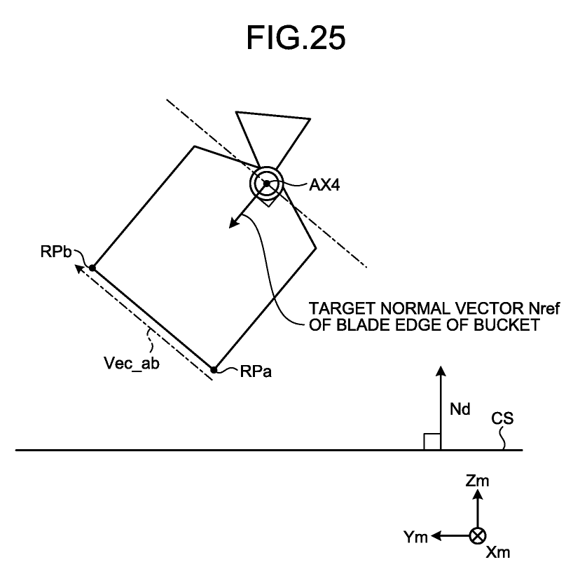

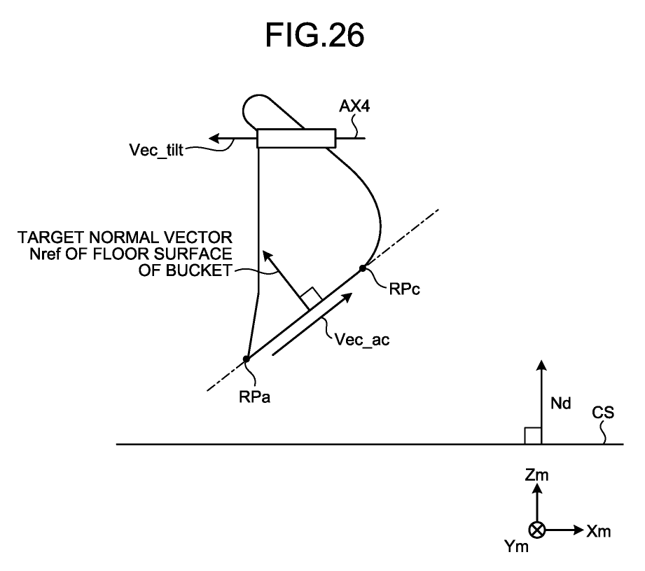

FIG. 24 is a flowchart illustrating an example of a method of adjusting an angle of the bucket 8 according to this embodiment. FIG. 25 and FIG. 26 are schematic views illustrating an example of the method of adjusting the angle of the bucket 8 according to this embodiment. FIG. 25 schematically illustrates an example of the method of adjusting the angle of the bucket 8 when the blade edge 9 of the bucket 8 and the target construction topography CS are made to be parallel with each other. FIG. 26 schematically illustrates an example of the method of adjusting the angle of the bucket 8 when the floor surface 89 of the bucket 8 and the target construction topography CS are made to be parallel with each other.

In the following description, the blade edge 9 and the floor surface 89 of the bucket 8 are appropriately referred to as a specific portion of the bucket 8 in a collective manner.

The specified point position data calculation unit 53 calculates position data of a specified point RPa specified to the blade edge 9, position data of a specified point RPb that is specified to the blade edge 9, and position data of a specified point RPc that is specified to the floor surface 89 (Step SB10).

As illustrated in FIG. 25, the specified point RPa and the specified point RPb are specified points on both sides in a width direction of the bucket 8 in the blade edge 9. The specified point position data calculation unit 53 calculates position data of the specified point RPa and position data of the specified point RPb in the vehicle body coordinate system.

As illustrated in FIG. 26, the specified point RPc is a specified point of a part of the floor surface 89 that is flat. In a width direction of the bucket 8, coordinates of the specified point RPa and coordinates of the specified point RPc are the same as each other. In this embodiment, the specified point RPa is specified to one end of the bottom plate 81, and the specified point RPc is specified to the other end of the bottom plate 81.

In addition, the specified point position data calculation unit 53 calculates a direction vector Vec_ab that connects the specified point RPa and the specified point RPb on the basis of the position data of the specified point RPa and the position data of the specified point RPb.

In addition, the specified point position data calculation unit 53 calculates a direction vector Vec_ac that connects the specified point RPa and the specified point RPc on the basis of the position data of the specified point RPa and the position data of the specified point RPc.

In addition, the specified point position data calculation unit 53 calculates a normal vector Vec_tilt of the tilt axis AX4.

The angle determination unit 57 calculates a target normal vector Nref of the specific portion of the bucket 8 which is parallel to the target construction topography CS (Step SB20).

For example, in a case where the target construction topography CS and the blade edge 9 of the bucket 8 are made to be parallel to each other, as illustrated in FIG. 25, the angle determination unit 57 calculates a target normal vector Nref of the blade edge 9 of the bucket 8 which is orthogonal to the direction vector Vec_ab of the blade edge 9 of the bucket 8. The target normal vector Nref of the blade edge 9 of the bucket 8 is specified to be orthogonal to the direction vector Vec_ab of the blade edge 9 of the bucket 8 on the tilt operation plane TP. The target normal vector Nref of the blade edge 9 of the bucket 8 is also orthogonal to the normal vector Vec_tilt of the tilt axis AX4.

In addition, in a case of making the target construction topography CS and the floor surface 89 of the bucket 8 parallel to each other, as illustrated in FIG. 26, the angle determination unit 57 calculates a target normal vector Nref of the floor surface 89 of the bucket 8 which is orthogonal to the direction vector Vec_ac of the floor surface 89 of the bucket 8. The floor surface 89 is a substantially flat surface. Accordingly, the target normal vector Nref of the floor surface 89 of the bucket 8 is uniquely determined.

The direction vector Vec_ab is specified by Expression (1) described above. The direction vector Vec_ac is specified by the following Expression (3).

Vec_ac=RPc−RPa (3)

The target normal vector Nref of the blade edge 9 of the bucket 8 is specified by the following Expression (4).

Nref(blade edge)=Vec_ab×Vec_tilt (4)

The target normal vector Nref of the floor surface 89 of the bucket 8 is specified by the following Expression (5).

Nref(floor surface)=Vec_ac×Vec_ab (5)

The target construction topography generation unit 54 calculates a normal vector Nd of the target construction topography CS (Step SB30).

The angle detection unit 57 calculates an evaluation function Q (Step SB40).

The evaluation function Q is the sum of an evaluation function Q1 indicating a parallelism error between the target normal vector Nref and the normal vector Nd, and an evaluation function Q2 indicating a distance Da between the blade edge 9 and the target construction topography CS. That is, the following Expressions (6), (7), and (8) are established.

Q1=1−Nref·Nd (6)

Q2=Da (7)

Q=Q1+Q2 (8)

In Expression (6), a condition in which the target normal vector Nref and the normal vector Nd become parallel to each other is a state in which an inner product thereof becomes 1. That is, the following Expression (9) is established.

Nref·Nd=1 (9)

Furthermore, in Expression (8), in a case where it is not necessary to bring the bucket 8 into contact with the target construction topography CS, Q may be Q1.

The angle detection unit 57 performs calculation processing by a predetermined numerical value calculation method so that the evaluation function Q of (8) becomes minimum. For example, in the calculation processing, a Newton method, a Powel method, a simplex method, and the like can be used.

The angle detection unit 57 determines whether or not the evaluation function Q becomes minimum (Step SB50). That is, the angle detection unit 57 performs calculation processing by a predetermined numeric operation method, and determines whether or not the evaluation function becomes substantially 0.

In Step SB50, in a case where it is determined that the evaluation function Q is minimum (Step SB50: Yes), the angle detection unit 57 calculates a tilt angle δr and a bucket angle γr of the specific portion of the bucket 8 for making the specific portion of the bucket 8 and the target construction topography CS parallel to each other (Step SB60). That is, the angle detection unit 57 determines the tilt angle δr and the bucket angle γr at which the evaluation function Q becomes minimum.

The tilt angle δr represents an angle of the specific portion of the bucket 8 around the tilt axis AX4 for making the target construction topography CS and the specific portion of the bucket 8 parallel to each other. The bucket angle γr represents an angle of the specific portion of the bucket 8 around the bucket axis AX3.

The working equipment control unit 58 controls the tilt cylinder 14 and the bucket cylinder 13 so that the target construction topography CS and the specific portion of the bucket 8 become parallel to each other on the basis of the tilt angle δr and the bucket angle γr which are determined by the angle determination unit 57 (Step SB70).

In Step SB50, in a case where it is determined that the evaluation function Q is not minimum (Step SB50: No), the angle detection unit 57 updates the tilt angle δr or the bucket angle γr (Step SB80), and it returns to the processing in Step SB40.

### Other Embodiments

Furthermore, in the above-described embodiment, with regard to the evaluation function Q, weighting may be performed to the evaluation function Q1 and the evaluation function Q2.

Furthermore, in the above-described embodiments, the construction machine 100 is assumed as the excavator. The constituent elements described in the embodiments are applicable to a construction machine including working equipment that is different from that of the excavator.

Furthermore, in the above-described embodiments, the upper swing body 2 may swing by a hydraulic pressure, or may swing by power that is generated by an electric actuator. In addition, the working equipment 1 may operate by power that is generated by an electric actuator instead of the hydraulic cylinder 10.

### REFERENCE SIGNS LIST

1 WORKING EQUIPMENT
2 UPPER SWING BODY
3 LOWER TRAVEL BODY
3C CRAWLER
4 DRIVING CHAMBER
5 MACHINE CHAMBER
6 BOOM
7 ARM
8 BUCKET
8B BUCKET PIN
8T TILT PIN
9 BLADE EDGE
10 HYDRAULIC CYLINDER
10A CAP SIDE OIL CHAMBER
10B ROD SIDE OIL CHAMBER
11 BOOM CYLINDER
12 ARM CYLINDER
13 BUCKET CYLINDER
14 TILT CYLINDER
16 BOOM STROKE SENSOR
17 ARM STROKE SENSOR
18 BUCKET STROKE SENSOR
19 TILT STROKE SENSOR
20 POSITION CALCULATION DEVICE
21 VEHICLE BODY POSITION CALCULATOR
22 POSTURE CALCULATOR
23 AZIMUTH CALCULATOR
24 WORKING EQUIPMENT ANGLE CALCULATION DEVICE
25 FLOW RATE CONTROL VALVE
30 OPERATION DEVICE
30F OPERATION PEDAL
30L LEFT WORKING EQUIPMENT OPERATION LEVER
30R RIGHT WORKING EQUIPMENT OPERATION LEVER
30T TILT OPERATION LEVER
31 MAIN HYDRAULIC PUMP
32 PILOT PRESSURE PUMP
33A, 33B OIL PATH
34A, 34B PRESSURE SENSOR
35A, 35B OIL PATH
36A, 36B SHUTTLE VALVE
37A, 37B CONTROL VALVE
38A, 38B OIL PATH
50 CONTROL DEVICE
51 VEHICLE BODY POSITION DATA ACQUISITION UNIT
52 WORKING EQUIPMENT ANGLE DATA ACQUISITION UNIT
53 SPECIFIED POINT POSITION DATA CALCULATION UNIT
54 TARGET CONSTRUCTION TOPOGRAPHY GENERATION UNIT
55 TILT DATA CALCULATION UNIT
56 TILT TARGET TOPOGRAPHY CALCULATION UNIT
57 ANGLE DETERMINATION UNIT
58 WORKING EQUIPMENT CONTROL UNIT
59 TARGET SPEED DETERMINATION UNIT
60 STORAGE UNIT
61 INPUT/OUTPUT UNIT
70 TARGET CONSTRUCTION DATA GENERATION DEVICE
81 BOTTOM PLATE
82 REAR PLATE
83 UPPER PLATE
84 SIDE PLATE
85 SIDE PLATE
86 OPENING
87 BRACKET
88 BRACKET
89 FLOOR SURFACE
90 CONNECTION MEMBER
91 PLATE MEMBER
92 BRACKET
93 BRACKET
94 FIRST LINK MEMBER
94P FIRST LINK PIN
95 SECOND LINK MEMBER
95P SECOND LINK PIN
96 BUCKET CYLINDER TOP PIN
97 BRACKET
100 EXCAVATOR (CONSTRUCTION MACHINE)
200 CONTROL SYSTEM
300 HYDRAULIC SYSTEM
400 DETECTION SYSTEM
AP POINT
AX1 BOOM AXIS
AX2 ARM AXIS
AX3 BUCKET AXIS
AX4 TILT AXIS
CD TARGET CONSTRUCTION DATA
CS TARGET CONSTRUCTION TOPOGRAPHY
Da OPERATION DISTANCE
L1 BOOM LENGTH
L2 ARM LENGTH
L3 BUCKET LENGTH
L4 TILT LENGTH
L5 BUCKET WIDTH
LX LINE
LY LINE
RP SPECIFIED POINT
RX SWING AXIS
ST TILT TARGET TOPOGRAPHY
TP TILT OPERATION PLANE
α BOOM ANGLE
β ARM ANGLE
γ BUCKET ANGLE
δ TILT ANGLE
ε TILT AXIS ANGLE
θ1 ROLL ANGLE
θ2 PITCH ANGLE
θ3 YAW ANGLE

1. A control system of a construction machine provided with working equipment including an arm and a bucket configured to rotate around each of a bucket axis and a tilt axis orthogonal to the bucket axis with respect to the arm, the control system comprising:
an angle determination unit configured to determine a tilt angle indicating an angle of a specific portion of the bucket around the tilt axis so that a target construction topography indicating a target shape of an excavation object and the specific portion of the bucket become parallel to each other; and
a working equipment control unit configured to control a tilt cylinder configured to rotate the bucket around the tilt axis on the basis of the tilt angle determined by the angle determination unit.

2. The control system of a construction machine according to claim 1,
wherein the angle determination unit is configured to determine a bucket angle indicating an angle of the specific portion of the bucket around the bucket axis so that the target construction topography and the specific portion of the bucket become parallel to each other, and
the working equipment control unit is configured to control the tilt cylinder and a bucket cylinder configured to rotate the bucket around the bucket axis on the basis of the tilt angle and the bucket angle which are determined by the angle determination unit.

3. The control system of a construction machine according to claim 2,
wherein the bucket includes a blade edge, and a flat floor surface connected to the blade edge, and
the specific portion includes the blade edge and the floor surface.

4. The control system of a construction machine according to claim 2,
wherein the working equipment control unit is configured to control at least one of the tilt cylinder and the bucket cylinder so that parallelism between the specific portion of the bucket and the target construction topography is maintained in a state in which the arm operates.

5. A construction machine, comprising:
an upper swing body;
a lower travel body configured to support the upper swing body;
working equipment that includes the arm and the bucket, the working equipment being configured to be supported to the upper swing body; and
the control system of the construction machine according to claim 1.

6. A control method of a construction machine provided with working equipment including an arm and a bucket configured to rotate around each of a bucket axis and a tilt axis orthogonal to the bucket axis with respect to the arm, the control method comprising:
determining a tilt angle indicating an angle of a specific portion of the bucket around the tilt axis so that a target construction topography indicating a target shape of an excavation object and the specific portion of the bucket become parallel to each other; and
controlling a tilt cylinder configured to rotate the bucket around the tilt axis on the basis of the determined tilt angle.
